(19) United States
(12) Patent Application Publication
(10) Pub. No.: US 2011/0171000 A1
(43) Pub. Date: Jul. 14, 2011

(54) WALKIE-RIDER TINE ATTACHMENT

(75) Inventor: Bruce Hailston, Midland, MI (US)

(73) Assignee: MAGLINE INCORPORATED, Standish, MI (US)

(21) Appl. No.: 12/986,300

(22) Filed: Jan. 7, 2011

Related U.S. Application Data
(60) Provisional application No. 61/293,935, filed on Jan. 11, 2010.

(51) Int. Cl. B66F 9/12; B66F 9/065; B62B 3/02; B66F 9/19

(52) U.S. Cl. 414/607; 414/800

(57) ABSTRACT

A walkie-rider pallet truck tine attachment comprising a lower portion which attaches to the tines of the pallet truck and is secured with set screws, and an upper portion which comprises two generally horizontal load-carrying surfaces which extend laterally beyond the width of the tine to provide greater stability, such that one load can be carried on each load-carrying surface. The attachment may include a telescopically adjustable connector between the load-carrying surfaces to provide them with additional stability. The attachment includes several features designed to facilitate proper positioning and stable transport such as lead in edges, pallet backstops, raised lateral edges of the load-carrying surface or pallet positioners.

### CROSS REFERENCE TO RELATED APPLICATIONS

Applicant claims priority to U.S. Provisional Application Ser. No. 61/293,935 entitled WALKIE-RIDER TINE ATTACHMENT, filed Jan. 11, 2010.

### FIELD OF THE INVENTION

The present invention relates generally to material handling, and more particularly to an attachment for the tines of a walkie-rider pallet truck for supporting and transporting loads.

### SUMMARY OF THE INVENTION

The invention relates to a tine attachment for a walkie-rider pallet truck, designed to slide over the standard tines of the walkie-rider pallet truck and be fastened securely thereto, providing a load-carrying upper surface above each of the standard pallet truck tines, which load-carrying surface extends laterally beyond the width of the tines to better support and transport loads, particularly loads other than, or in addition to, standard wooden pallets. The lateral extension of the load-carrying surface allows each tine to carry its own narrowed pallet in a stable and secure manner, without the use of the other tine, such that two narrow pallets can be carried simultaneously without stacking the pallets. The pallet truck tine attachment may also be customized to the particular pallet or load being transported to further facilitate loading and provide stability and support while transporting the load, for example, by adding positioning or retention features that coordinate with the particular pallet or load being transported.

### BRIEF DESCRIPTION OF THE DRAWINGS

FIG. 1 is a top perspective view of the walkie-rider pallet truck tine attachment.

FIG. 2 is a side view of a walkie-rider pallet truck tine attachment.

FIG. 3 is a plan view of the walkie-rider pallet truck tine attachment from the rear end of the attachment.

FIG. 4 is a bottom view of the walkie-rider pallet truck tine attachment.

FIG. 5 is a side view of a walkie-rider pallet truck.

FIG. 6 is a top perspective view of the walkie-rider pallet truck tine attachment illustrating the use of a securing spring pin.

FIG. 7 is a rear perspective view of the walkie-rider pallet truck tine attachment illustrating the use of a securing spring pin, and showing primarily the bracket portion of the pallet truck tine attachment which attaches to the tines.

### DESCRIPTION OF THE PREFERRED EMBODIMENTS

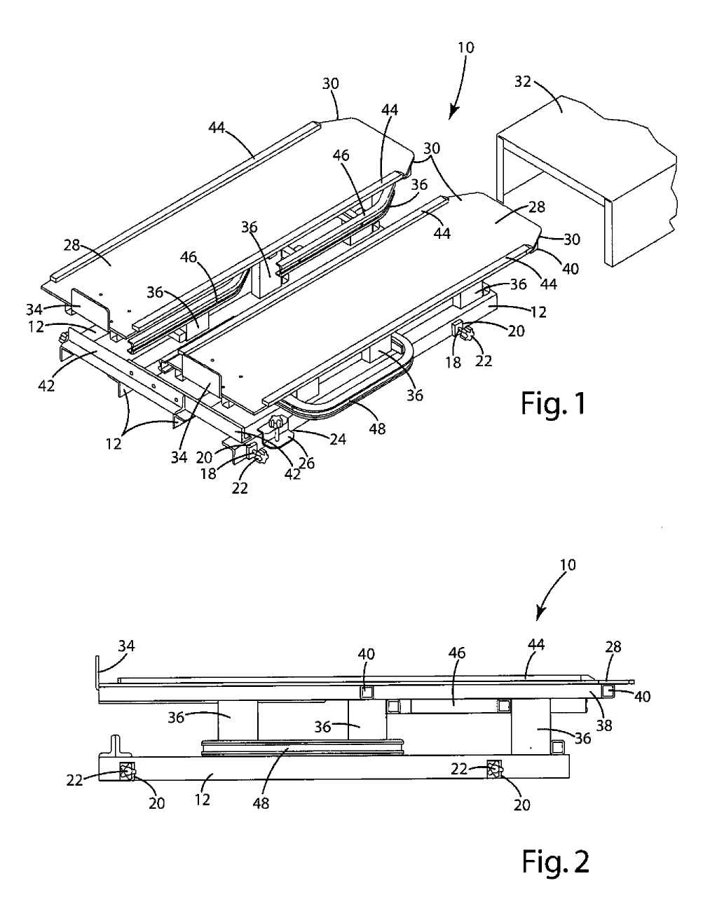

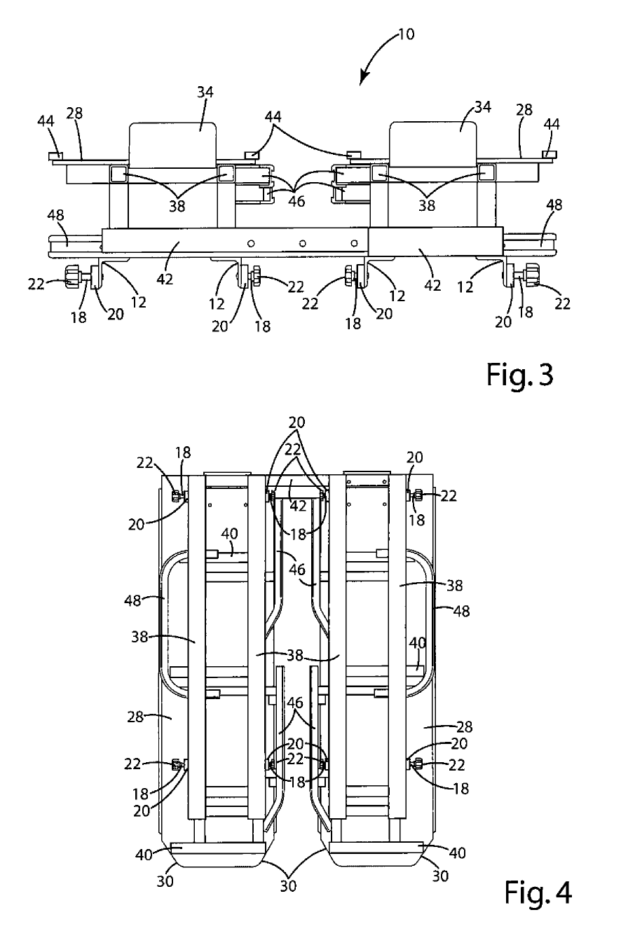

In one preferred embodiment of the walkie-rider tine attachment 10 as shown best in FIGS. 1 and 3, there are two extended L-shaped brackets 12 which fit over each tine 14 of the pallet truck 16 (for a total of four brackets 12). Each set of two brackets 12 is positioned to receive one tine 14 of the pallet truck 16 with one leg of each bracket 12 in a horizontal orientation and extending toward the other bracket 12 in the set, and the other leg of each bracket 12 extending downward, spaced so that the vertical portion of the brackets 12 in the set is laterally spaced wider than the tine 14, but in close proximity thereto. The horizontal legs of the brackets 12 in each set of two brackets 12 may or may not be joined across the top to form a 3-sided rectangular cross section.

In one preferred embodiment of the invention, each bracket 12 has two set screws 18 which extend through the vertically oriented portion of the bracket 12, one generally on the forward portion of each bracket 12 and the other generally on the rear portion of each bracket 12, for a total of 8 set screws to secure the tine attachment 10. The set screws 18 may be inserted through an additional brace 20 as shown in FIG. 1 to provide additional stability, and also may be equipped with knobs 22 to permit hand-tightening by operators. The system of brackets 12 and set screws 18 allows the tine attachment 10 to sit securely on top of the tines 14 without interfering with features of the tines 14 such as wheels on the underside of the tines 14 which may be present in some models of pallet trucks 16.

To further secure the brackets 12 on the pallet truck tines 14, a securing hook 24 may be provided at the rear end of the bracket 12, or on the rear end of some of the brackets 12. The securing hooks 24 include an L-shaped or hook-shaped piece that is attached to a horizontal extension 26 which extends laterally from the bracket 12, with the securing hook 24 extending through the horizontal faces of the horizontal extension 26 around the outside of the bracket 12, and then under the tine 14, such that the tine attachment 10 is secured against vertical movement.

Each set of two brackets 12 is ultimately joined to an upper, generally horizontal load-carrying surface 28. The load-carrying surface 28 is generally coextensive with the length of the tine 14, although it may extend lengthwise beyond the forward end of the tine 14, and extends laterally beyond the width of the tine 14. In the preferred embodiments shown in FIGS. 1 and 4, each load-carrying surface 28 is generally rectangular in shape, with angled lead-in edges 30 on the front two corners of the load-carrying surface 28 (farthest from the operator). The angled lead-in edges 30 on the forward end of the load-carrying surface provide more leeway for the operator to position the tine attachment 10 and facilitate the operator's ability to pick up a pallet 32. The rear edge of each load-carrying surface 28 is defined by a pallet back stop 34 to assist in positioning of the pallet 32 on the load-carrying surface 28 and prevent the pallet 32 from interfering with the tine attachment 10 and its interface with the tines 14 and pallet truck 16. The laterally extended load-carrying surface 28 provides additional stability to the pallet 32 so that a pallet 32 can be carried on each tine 14, and two pallets 32 can be transported at the same time in a secure and stable manner.

Each load-carrying surface 28 is attached to the set of brackets 12 corresponding to the same tine 14 by connecting means 36 designed to raise the load-carrying surface 28 such that it can be used to pick up pallets 32 with a higher ground clearance, despite the generally limited vertical travel of the tines 14 in a pallet truck 16. One example of such a pallet 32 with a higher ground clearance would be the pallet 32 described in U.S. application Ser. No. 12/578,834, filed Oct. 14, 2009, which claims priority from U.S. Provisional Application Ser. No. 61/106,975 (which application is herein incorporated by reference). The connecting means 36 may be customized to the height of the particular pallets 32 to be handled using the tine attachment 10, and may consist of a single piece connected to each bracket 12 and each load-carrying surface 28, or multiple pieces, so long as the rigidity and strength of the connecting means 36 is sufficient to support the load-carrying surface 28 and the pallet 32 to be carried thereon. For example, in the embodiment shown in FIG. 1, the connecting means 36 consists of three pieces connected to the top side of the horizontally-oriented leg of each bracket 12 and the underside of the load-carrying surface 28.

Also, as illustrated in FIG. 2, the load-carrying surface 28 may also be stabilized and reinforced on the underside by a beam 38 which extends along the length of the load-carrying surface 28 and connects to the connecting means 36 instead of directly attaching the connecting means 36 to the load-carrying surface 28. Additionally, as shown in FIGS. 1 and 4, to further stabilize and reinforce the load-carrying surface 28, a horizontal cross piece 40 may be provided on the underside of the load-carrying surface 28 at or near the front end of the load-carrying surface and at intervals along the length of the load-carrying surface 28 if desired to provide a stronger and more rigid surface. A horizontal connecting piece 42, which may be adjustable in length, may also be attached to the rear end of the brackets 12 to further stabilize and reinforce the tine attachment 10.

As shown in FIGS. 1, 2 and 3, to further facilitate the stable transport of the pallet 32 the load-carrying surface 28 may have raised edges 44 along the length of the load-carrying surface 28 to provide a greater surface area which is in contact with the underside of a particular pallet 32 or to interlock with the features on the underside of a particular pallet 32. For example, the pallet 32 described in U.S. application Ser. No. 12/578,834, filed Oct. 14, 2009, includes features on the underside of the pallet's 32 body which extend downward to securely interlock with the features of a particular hand truck and limit lateral movement of the pallet 32. These features may make the pallet 32 less stable on the tine attachment 10 if they are to provide the only supporting engagement with the load-carrying surface 28 of the tine attachment 10. To provide a more stable base under the pallet 32, and to similarly limit lateral movement of the pallet 32, raised edges 44, which are preferably at least as tall as the height of the downwardly extending features on pallet 32, may be provided on the lateral edges of the load-carrying surface 28 as shown herein. Additionally, the lateral raised edges 44 of the load-carrying surface 28 may also be provided with knobs or notches or any other shape for engaging mating surfaces on the pallet 32, to further facilitate a stable interface between the load-carrying surface 28 and the lower surface of the pallet 32.

To position a particular pallet 32, as best shown in FIGS. 1, 2 and 4, the load-carrying surfaces 28 may have inboard pallet postitioners 46 or outboard pallet postitioners 48, or both. The inboard pallet postitioner 46 or the outboard pallet postitioner 48 may consist of one or more rails extending horizontally from the load-carrying surface 28 (or the structures supporting the load-carrying surface, such as a reinforcing beam 38 if present, the connecting means 36, or the bracket 12, depending on the design of the pallet 32 to be used with the attachment 10 and the interface between the pallet 32 and the attachment 10). The inboard pallet postitioner 46 and outboard pallet postitioner 48 may be connected to the rest of the attachment 10 using one or more connection points and one or more reinforcing pieces, as desired to accommodate the intended pallet 32. The inboard pallet postitioner 46 extends from the load-carrying surface 28 into the space between the load-carrying surfaces 28 and the outboard pallet postitioner 48 extends to the outside of each load-carrying surface 28, away from the other load-carrying surface 28.

In one preferred embodiment as shown in FIGS. 1 and 4, the inboard pallet postitioner 46, comprises more than one piece, with each piece having a lead-in that angles back and away from the front portion of the load-carrying surface 28 and then a body which is oriented substantially parallel with the edge of the load carrying surface 28. The position, length, size and shape of the inboard pallet postitioner 46 may vary based on the design of the pallet 32 to be loaded.

As shown in FIG. 1, the outboard pallet postitioner 48 may (but is not necessarily required to) have a shape which varies from that of the inboard pallet postitioner 46. In the preferred embodiment illustrated in FIGS. 1 and 4, the outboard pallet postitioner 48 is in a semi-rectangular shape, with rounded corners. As with the inboard pallet postitioner 46, the desired position, length, size and shape of the outboard pallet postitioner 48 will be determined by the particular pallet 32 with which the attachment 10 is intended to be used. Additionally, the outboard pallet positioner 48 may be fastened directly to the underside of the load carrying surface 28 or may be attached to the attachment 10 on a lower section of the frame of the attachment 10, such as the reinforcing beam 38, the connecting means 36 or the bracket 12. By lowering the connection of the outboard pallet positioner 46 to the attachment 10, additional stabilization may be provided for pallets 32 with increased ground clearance, as described herein, because if the pallets 32 have a tendency to rotate outward, the outboard pallet positioner 46 would provide additional stabilization that may be able to limit or prohibit movement of the leg of the pallet 32.

The inboard pallet postitioner 46 and outboard pallet postitioner 48 are fixed in location at least while the attachment 10 is in use, and operate to force the pallets 32 into the proper position on the load carrying surfaces 28. Inboard pallet positioner 46 defines the maximum allowable gap between adjacent pallets 32 on the load-carrying surface 28 and outboard pallet positioner 48 defines the minimum allowable gap between adjacent pallets 32 on the load-carrying surface 28. Generally, it may be desirable to maintain at least 0.5 inches of minimum separation between the pallets 32 to prevent their interference with each other.

The set screws 18, described herein may also be used to define the minimum desired gap between pallets 32. To achieve the minimum desired gap, the set screws 18 located on the forward portion of the inward facing brackets 12 may be hand tightened by the operator against the tines 14 of the pallet truck 16. Further tightening of the set screws will cause the overall width of the tine attachment 10 to be reduced, due to a reduction in the gap between the load-carrying surfaces. After the inward forward set screws 18 have been tightened to achieve the desired minimum desired gap between pallets 32, the remainder of the set screws 18 can be tightened against the tines 14 of the pallet truck 16 to securely fasten the tine attachment 10 to the tines 14.

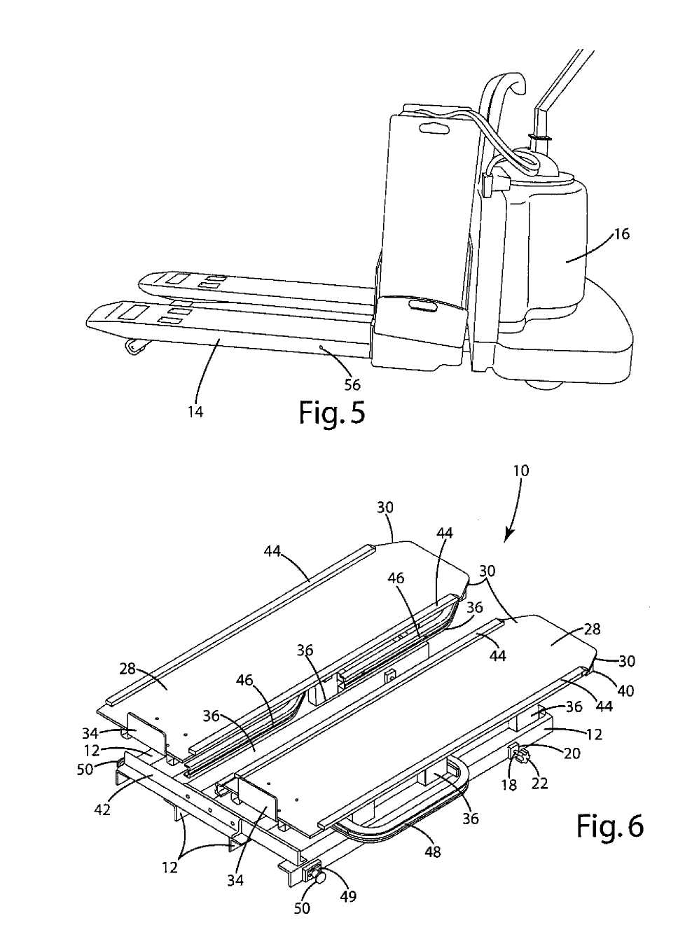

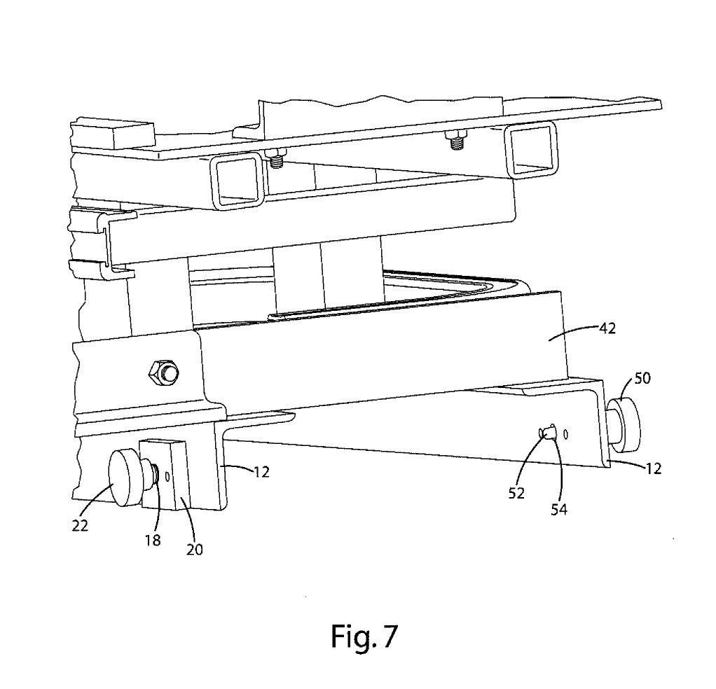

In another embodiment, a securing spring pin 49 may be used to secure the bracket 12 to the tine 14 of the pallet truck 16. (FIGS. 5-7) The securing spring pin 49 may be provided at the rear end of the bracket 12, facing outwardly, and positioned to allow it to extend through the vertically oriented portion of the bracket 12. The securing spring pin 49 comprises a handle 50, which can be rotated ninety degrees by the operator to release a spring loaded pin 52 through an opening 54 in the vertically oriented portion of the bracket 12 and into a recess 56 in the tine 14 of the pallet truck 16. The handle 50 may also be used by an operator to pull the spring loaded pin 52 horizontally out of the recess 56 and the opening 54 in the vertically oriented portion of the bracket 12 and then rotate the spring loaded pin 52 ninety degrees to lock the spring loaded pin 52 in the retracted position. Such a securing spring pin 49 may take the place of any securing hooks 24 which would be used, and will eliminate the need for a set screw 18 on the rear, outward facing portion of the bracket 12.

By the foregoing description, it will be readily appreciated by those skilled in the art that modifications may be made to the invention without departing from the concepts disclosed herein. Such modifications are to be considered as included in the invention and the claims, unless the claims by their language expressly state otherwise.

1. A walkie-rider pallet truck tine attachment device, comprising:
A generally flat load carrying surface, extending laterally beyond the width of a walkie-rider tine, wherein the load carrying surface further comprises raised guides to interact with the load to be carried on the load carrying surface so as to stabilize the position of the load on the load carrying surface; and
A frame affixed to the lower surface of the load carrying surface, wherein the frame comprises at least one bracket to fit over the pallet truck tine which does not compromise the operation of the tine and which is removably secured to the pallet truck tine.

2. The walkie-rider pallet truck tine attachment of claim 1, wherein the frame further comprises a riser which is used to raise the height of the load carrying surface to permit interaction with loads having an increased ground clearance.

3. The walkie-rider pallet truck tine attachment device of claim 2, having a pair arms, with each arm comprising a load carrying surface, a riser, and a bracket.

4. The walkie-rider pallet truck tine attachment device of claim 3, wherein each load carrying surface is complimentarily shaped to a predetermined type of pallet so that two pallets can be carried in side-to-side arrangement by the walkie-rider pallet truck tine attachment device.

5. The walkie-rider pallet truck tine attachment device of claim 4, further comprising an inboard pallet positioning rail affixed to and extending from one arm toward the space between the load carrying surfaces.

6. The walkie-rider pallet truck tine attachment device of claim 5, further comprising an outboard pallet positioning rail affixed to and extending from one arm in a direction away from the other arm.

7. The walkie-rider pallet truck tine attachment device of claim 4, further comprising an outboard pallet positioning rail affixed to and extending from one arm in a direction away from the other arm.

8. The walkie-rider pallet truck tine attachment device of claim 1, wherein the raised guides are present on the lateral edges of the load carrying surface.

9. The walkie-rider pallet truck tine attachment device of claim 4, wherein the raised guides are present on the lateral edge of each load carrying surface, and are complimentary to the shape of the underside of the pallets for use with the walkie-rider pallet truck tine attachment device.

10. The walkie-rider pallet truck tine attachment device of claim 1, wherein the bracket is removably attached to the tines using set screws.

11. The walkie-rider pallet truck tine attachment device of claim 1, wherein the bracket is removably attached to the tines using spring-loaded pins.

12. The walkie-rider pallet truck tine attachment device of claim 3, further comprising complementary telescopically connectable pieces affixed to each arm, such that the arms are capable of being telescopically connected to each other at an adjustable width.

13. The walkie-rider pallet truck tine attachment device of claim 12, further comprising an inboard pallet positioning rail affixed to and extending from one arm toward the space between the load carrying surfaces.

14. The walkie-rider pallet truck tine attachment device of claim 13, wherein the inboard pallet positioning rail is angled away from the front edge of the arm, and extends rearwardly therefrom.

15. The walkie-rider pallet truck tine attachment device of claim 13, further comprising an outboard pallet positioning rail affixed to and extending from one arm in a direction away from the other arm.

16. The walkie-rider pallet truck tine attachment device of claim 10, further comprising an outboard pallet positioning rail affixed to and extending from one arm in a direction away from the other arm.

17. A method of using the walkie-rider pallet truck tine attachment device of claim 3, comprising the following steps:
Aligning a first arm of the walkie-rider pallet truck tine attachment device with a first pallet and moving the walkie-rider pallet truck tine attachment device forward to be positioned underneath the first pallet, and lifting the first pallet; and
Aligning a second arm of the walkie-rider pallet truck tine attachment device with a second pallet and moving the walkie-rider pallet truck tine attachment device forward to be positioned underneath the second pallet and lifting the second pallet.

18. The method of claim 17, wherein the first and second arms are simultaneously aligned with the first and second pallets.

19. The method of claim 18, wherein the walkie-rider pallet truck tine attachment device further comprises an inboard pallet positioning rail to aid in the alignment of the arms with the pallets.

20. The method of claim 19, wherein the walkie-rider pallet truck tine attachment device further comprises an outboard pallet positioning rail to aid in the alignment of the arms with the pallets.

21. The method of claim 17, wherein the walkie-rider pallet truck tine attachment device further comprises an outboard pallet positioning rail to aid in the alignment of the arms with the pallets.
